(19) United States
(12) Patent Application Publication
(10) Pub. No.: US 2009/0313776 A1
(43) Pub. Date: Dec. 24, 2009

(54) SUBSTRATE CLEANING APPARATUS

(75) Inventors: Nobuhiko MOURI, Koshi City (JP); Satoru TANAKA, Tosu City (JP)

Correspondence Address: CANTOR COLBURN, LLP, 20 Church Street, 22nd Floor, Hartford, CT, 06103, US

(73) Assignee: TOKYO ELECTRON LIMITED, Tokyo (JP)

(21) Appl. No.: 12/487,259

(22) Filed: Jun. 18, 2009

(30) Foreign Application Priority Data
Jun. 18, 2008 (JP) 2008-159034

(51) Int. Cl. B08B 1/02; B08B 11/02

(52) U.S. Cl. 15/88.2; 15/77

(57) ABSTRACT

Disclosed is a substrate cleaning apparatus capable of efficiently removing extraneous matters attached on a periphery of the substrate with a brush. The substrate cleaning apparatus includes a spin chuck to rotatably hold a wafer a motor to rotate the wafer held by the spin chuck, a cleaning liquid supplying device to supply cleaning liquid to the wafer held by the spin chuck, and a cleaning device including a brush, a rotating device and a pressing device. The brush includes a periphery cleaning part in contact with a periphery of the wafer during cleaning. The rotating device rotates the brush, and the pressing device pushes the brush to the wafer. The periphery cleaning part includes a changing part. The property of the changing part is changed along a diameter of the periphery cleaning part to distribute cleaning performance.

This application is based on and claims priority from Japanese Patent Application No. 2008-159034, filed on Jun. 18, 2008 with the Japanese Patent Office, the disclosure of which is incorporated herein in its entirety by reference.

### TECHNICAL FIELD

The present invention relates to a substrate cleaning apparatus capable of brush-cleaning a periphery of a substrate.

### BACKGROUND

A manufacturing process of a semiconductor device or Flat Panel Display (FPD) includes a cleaning process to remove particles or pollutants attached on a target object, such as semiconductor wafer or a glass substrate. As one example of a cleaning apparatus, there is a single-type cleaning apparatus. The single-type cleaning apparatus holds a substrate with a spin chuck and supplies cleaning liquid to a surface of a wafer while rotating the substrate so as to clean the surface of the wafer.

A chemical liquid of acid or alkali for cleaning liquid remains on a periphery of the substrate and dries to become extraneous matters (or sticked matter) during the cleaning process of the cleaning apparatus. Further, the materials removed through the cleaning process are re-attached onto the periphery of the substrate. Any process or apparatus was not suggested to treat the extraneous matters on the periphery of the substrate since the periphery of the substrate was not used as a commercial product. However, such extraneous matters affect a performance of a semiconductor device as the semiconductor device becomes finer, because the extraneous matters that are formed on the periphery of the substrate are attached on a substrate supporting arm of a substrate transfer device. Accordingly, it has been suggested a technology of removing the extraneous matters on a periphery of the substrate by contacting a sponge-type brush with the periphery of the substrate. Examples of such technology are disclosed in Japanese Utility Model Laid-open Publication Hei 5-79939 and Japanese Patent Laid-open Publication No. 2007-165794.

However, a brush-cleaning process of extraneous matters is not easily performed when the extraneous matters are firmly attached to a periphery of a substrate. A bevel of the periphery of the substrate further makes the brush-cleaning process difficult. Particularly, because the periphery of the substrate (for example, a semiconductor wafer) has surfaces that are diametrically opposite, a cleaning performance of a sponge-type brush is different for the surfaces. Thus, the extraneous matters cannot be efficiently removed by simply contacting the sponge-type brush with the slanted periphery of the substrate.

### SUMMARY

In accordance with one embodiment, a substrate cleaning apparatus is provided. The substrate cleaning apparatus includes a substrate holding device to rotatably hold a substrate, a substrate rotation device to rotate the substrate held by the substrate holding device, a cleaning liquid supplying device to supply cleaning liquid to the substrate held by the substrate holding device, and a cleaning device including a brush and a pressing device, the brush including a periphery cleaning part in contact with a periphery of the substrate during cleaning of the substrate, the pressing device pushing the periphery cleaning part to the periphery of the substrate. The periphery cleaning part includes a changing part, and the property of the changing part changes along a diameter of the periphery cleaning part to distribute cleaning performance along the diameter.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic view of an illustrated substrate cleaning apparatus according to one embodiment of the present invention.

FIG. 2 is a plane view illustrating an inside the substrate cleaning apparatus shown in FIG. 1.

FIG. 3 is a schematic view illustrating the cleaning device shown in FIG. 1.

FIG. 4 is an enlarged schematic view illustrating the brush and the brush support member of the cleaning device shown in FIG. 3, according to one embodiment.

FIG. 5 is an enlarged schematic view illustrating the brush and the brush support member of the cleaning device shown in FIG. 3, according to another embodiment.

FIG. 6 is an enlarged schematic view illustrating the brush and the brush support member of the cleaning device shown in FIG. 3, according to still another embodiment.

FIG. 7 is an enlarged schematic view illustrating the brush and the brush support member of the cleaning device shown in FIG. 3, according to still another embodiment.

FIG. 8 shows enlarged schematic views illustrating (a) different heights and (b) different densities of the bristles in the brush of the cleaning device shown in FIG. 3 according to still another embodiment.

FIG. 9 is an enlarged schematic top view illustrating the brush and the brush supporting member of the clearing device shown in FIG. 3, according to still another embodiment.

FIG. 10 is an enlarged schematic top view illustrating the brush and the brush support member of the cleaning device shown in FIG. 3, according to still another embodiment.

FIG. 11 is a block diagram illustrating a control part provided on the substrate cleaning apparatus shown in FIG. 1.

FIG. 12 is an enlarged schematic view illustrating a bevel of a wafer that is processed by the substrate cleaning apparatus shown in FIG. 1.

FIG. 13 is an enlarged schematic view illustrating the brush shown in FIG. 3, according to still another embodiment.

FIG. 14 shows enlarged schematic views (a) and (b) each illustrating the brush shown in FIG. 3, according to still another embodiment.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

The present invention provides a substrate cleaning apparatus capable of efficiently removing extraneous matters attached on a periphery of a substrate with a brush.

In accordance with one embodiment, a substrate cleaning apparatus is provided. The substrate cleaning apparatus includes a substrate holding device to rotatably hold a substrate, a substrate rotation device to rotate the substrate held by the substrate holding device, a cleaning liquid supplying device to supply cleaning liquid to the substrate held by the substrate holding device, and a cleaning device including a brush and a pressing device. The brush includes a periphery cleaning part in contact with a periphery of the substrate during cleaning of the substrate. The pressing device pushes the periphery cleaning part to the periphery of the substrate. The periphery cleaning part includes a changing part, and a property of the changing part changes along a diameter of the periphery cleaning part to distribute cleaning performance along the diameter.

At least one of height, shape, hardness, and material of the changing part may be changed along the diameter of the periphery cleaning part. The changing part may be divided into a plurality of parts along the diameter of the periphery cleaning part. At least one of height, shape, hardness, and material of the plurality of parts may be different between the adjacent parts.

The cleaning device may further include a brush rotating device to rotate the brush. The brush rotating device may rotate the brush and the pressing device may push the periphery cleaning part to the periphery of the substrate, thereby cleaning the periphery of the substrate. The periphery cleaning part may be divided into a plurality of brush parts along a circumferential direction. Properties between the adjacent brush parts may be different, and at least one of the brush parts may function as the changing part.

The periphery cleaning part may be supported by a brush supporting member.

The brush may be integrally and coaxially formed with the periphery cleaning part and may include an end surface cleaning part to be in contact with an end surface of the substrate. The end surface cleaning part may be formed with a sponge-type resin, and the pressing device may push the end surface cleaning part to the end surface of the substrate.

According to some embodiments, when cleaning the periphery of the substrate while being in contact with the brush, the property of the periphery cleaning part of the brush is changed along the diameter of the periphery cleaning part to distribute the cleaning performance in a diametrical direction of the periphery cleaning part. Therefore, an efficient removing of extraneous matters can be achieved even in the case that the property of the substrate is different along a diameter of the substrate. Thus, the efficient removing of the extraneous matters at a bevel of a semiconductor wafer can be achieved.

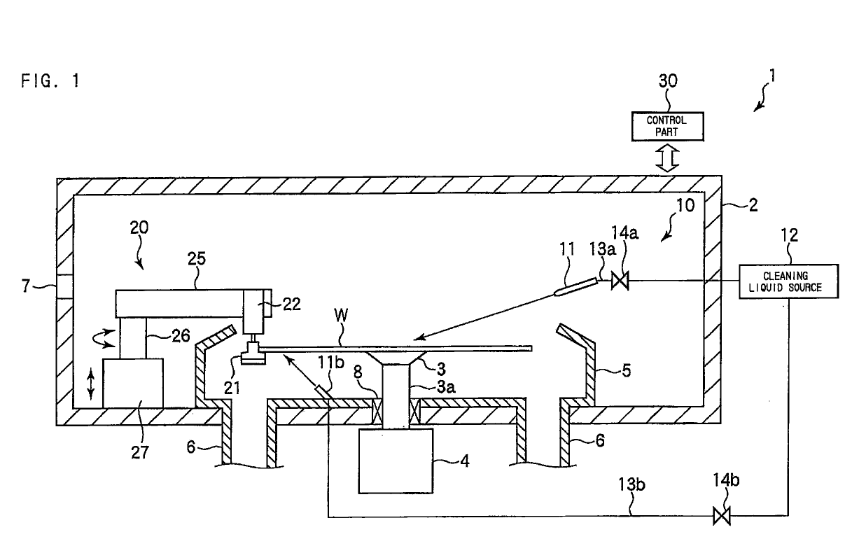

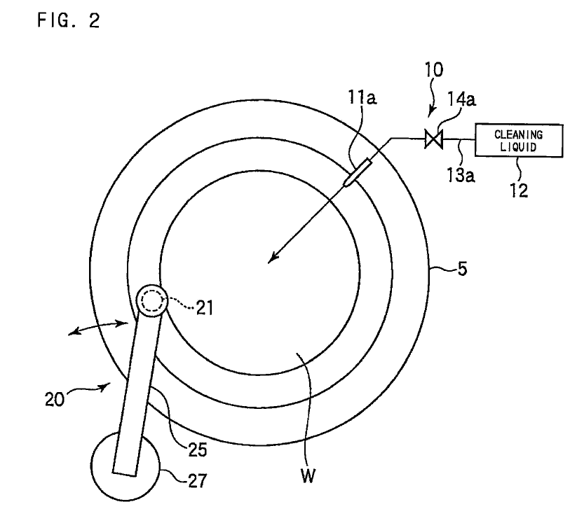

FIG. 1 is a schematic view of an illustrated substrate cleaning apparatus according to one embodiment of the present invention. FIG. 2 is a plane view illustrating an inside the substrate cleaning apparatus shown in FIG. 1.

A substrate cleaning apparatus 1 includes a chamber 2, and chamber 2 includes a spin chuck 3 on chamber 2. Spin chuck 3 holds a target object, for example, a semiconductor wafer W (hereinafter “wafer W”) in a horizontal state through vacuum absorbing. Spin chuck 3 is configured to rotate by a motor 4 that is provided on a lower side of chamber 2 through an axis 3a. Further, a cup 5 is provided within chamber 2 to cover wafer W held by spin chuck 3. A gas/liquid discharge pipe 6 is provided on a bottom part of cup 5 to discharge gas and liquid, and extends toward a downside of chamber 2. A loading/unloading port 7 is formed on a side wall of chamber 2 to load/unload wafer W. Further, a fluid seal 8 is provided between axis 3a and bottom parts of cup 5 and chamber 2.

Further, substrate cleaning apparatus 1 may further include a cleaning liquid supplying device 10 to supply cleaning liquid, and a cleaning device 20 to clean a periphery of wafer W with a brush.

Cleaning liquid supplying device 10 includes an upper surface-side cleaning liquid nozzle 11a provided on an upper surface of cup 5 and a rear surface-side liquid nozzle 11b provided on a rear surface of wafer W held by spin chuck 3. Upper surface-side cleaning liquid nozzle 11a and rear surface-side liquid nozzle 11b are connected with one ends of a surface-side cleaning liquid supplying pipe 13a and a rear surface-side liquid supplying pipe 13b, respectively. The other ends of both surface-side cleaning liquid supplying pipe 13a and rear surface-side liquid supplying pipe 13b are commonly connected to a cleaning liquid source 12. Upper surface-side cleaning liquid nozzle 11a supplies the cleaning liquid from cleaning liquid source 12 to an area near a center of a surface of wafer W through upper surface-side cleaning liquid supplying pipe 13a, and rear surface-side liquid nozzle 11b supplies the cleaning liquid from cleaning liquid source 12 to rear surface of wafer W through rear surface-side liquid supplying pipe 13b. Upper surface-side cleaning liquid supplying pipe 13a and rear surface-side liquid supplying pipe 13b include valves 14a and 14b, respectively. Deionized water or chemical liquid can be used as the cleaning liquid.

Cleaning device 20 includes a brush 21 to clean the periphery and an end surface of wafer W, a rotation supporting member 22 configured to rotatably support brush 21, a rotating arm 25 to rotate brush 21, a shaft part 26 including a rotating shaft that is a rotation axis of rotating arm 25, a rotating device to rotate the rotating shaft so as to rotate rotating arm 25, and a rotating/lifting part 27 including a lifting device that lifts rotating arm 25. Brush 21 is supported by a brush supporting member 23 at a lower side of brush 21.

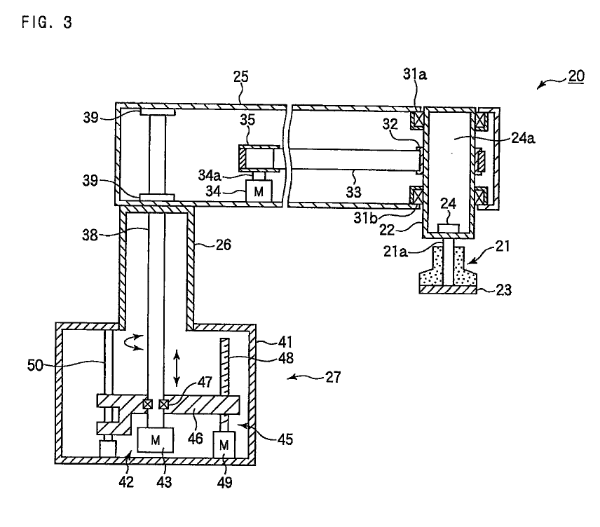

FIG. 3 is a schematic view illustrating the cleaning device shown in FIG. 1. Rotation supporting member 22 has a cylinder-like shape that extends in a vertical direction and includes a brush attaching part 24 at a center of a lower end of rotation supporting member 22. Brush attaching part 24 is attached with a brush supporting axis 21a extending from a center of brush 21 in a vertical direction. A lower end of brush supporting axis 21a is fixed to a center of brush supporting member 23. Brush supporting axis 21a is configured to attach/detach to/from brush attaching part 24.

Rotating arm 25 has an angled pipe-like shape that extends in a horizontal direction and rotation supporting member 22 is rotatably provided on a leading end of rotating arm 25. Rotation supporting member 22 is rotatably supported by a pair of bearings 31a and 31b which is attached to rotating arm 25. A pulley 32 is exteriorly fitted with a center of the rotation supporting member 22, and a belt 33 is wound around pulley 32. Belt 33 extends horizontally in an inner space of rotating arm 25. A motor 34 for brush rotation is provided in rotating arm 25, and is fixed to a bottom surface of rotating arm 25. A rotation axis 34a of motor 34 for brush rotation is attached with pulley 35, and belt 33 is wound around pulley 35. Therefore, rotation supporting member 22 is rotated through belt 33 by the operation of motor 34, and brush 21 is rotate together with rotation supporting member 22.

A vertically extending rotating shaft 38 is fixed to a base end of rotating arm 25 by a pair of fixing members 39 each provided on upper and lower portions inside rotating arm 25. Rotating shaft 38 passes through shaft part 26, and extends up to rotating/lifting part 27.

Rotating/lifting part 27 includes a case 41 extending downwardly from shaft part 26, and a rotating device 42 and lifting device 45 provided within case 41. Rotating device 42 includes a motor 43 for rotation. A rotation axis of motor 43 for rotation is connected with a lower end of rotating shaft 38, so that rotating arm 25 fixed to rotating shaft 38 can be rotated through the operation of motor 43 for rotation. Further, lifting device 45 includes a supporting member 46 to rotatably support rotating shaft 38 through a bearing 47, a ball screw 48 vertically extending from a bottom plate of case 41 to screw into supporting member 46, a motor 49 for lifting fixed to a bottom plate of case 41 to rotate ball screw 48, and a guide member 50 vertically provided inside case 41 to guide supporting member 46. Lifting device 45 lifts rotating shaft 38 through a ball screw device so as to lift rotating arm 25 together with rotating shaft 38. Further, rotating arm 25 is rotated through rotating device 42 and is lifted through lifting device 45 so as to press brush 21 toward a periphery of wafer W with a desired pressure. Rotating device 42 and lifting device 45 function as a pressing device of brush 21.

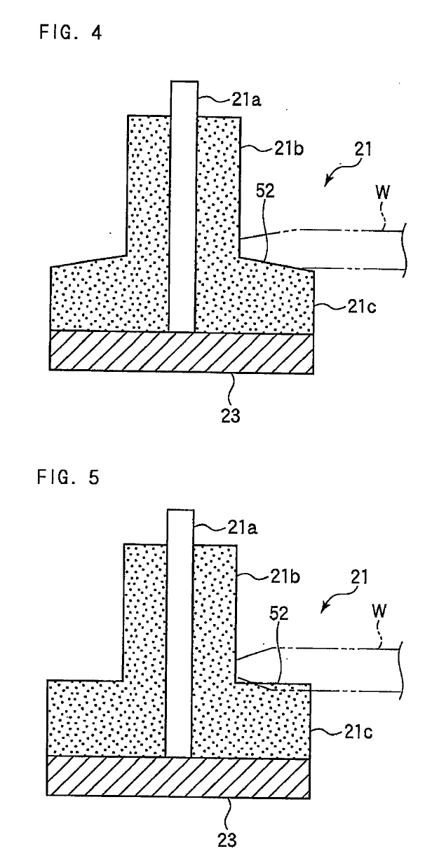

FIG. 4 is an enlarged schematic view illustrating the brush shown in FIG. 3. Brush 21 includes an end-surface cleaning part 21b that has a cylinder-like shape and a small diameter, and a periphery cleaning part 21c that has a cylinder-like shape and a large diameter. Periphery cleaning part 21 is integrally formed with a lower side of end-surface cleaning part 21b. A circumferential surface of end-surface clearing part 21b is in contact with the end surface of wafer W so as to clean the end surface of wafer W An upper surface of periphery cleaning part 21c is in contact with the periphery of the rear surface of wafer W so as to clean the periphery of the rear surface of wafer W

Periphery cleaning part 21c has a changing part 52 on which a property of periphery cleaning part 21c is changed along a diameter of periphery cleaning part 21c to distribute cleaning liquid along the diameter. Periphery cleaning part 21c, as depicted in FIG. 4, is, for example, entirely made of sponge-type resin. In this illustrated example, changing part 52 has a height that becomes higher as it goes towards the inner side of periphery cleaning part 21c along the diameter. Therefore, the cleaning performance of brush 21 can be increased as it goes toward the end-surface of wafer W.

Further, as shown in FIG. 5, changing part 52 of brush 21 can be controlled such that the height of periphery cleaning part 21c is substantially the same along the diameter of periphery cleaning part 21c, while becoming solid or to be composed of different materials as it goes toward the inner side of periphery cleaning part 21c. Therefore, the cleaning performance of brush 21 can be increased as it goes toward the end-surface of wafer W.

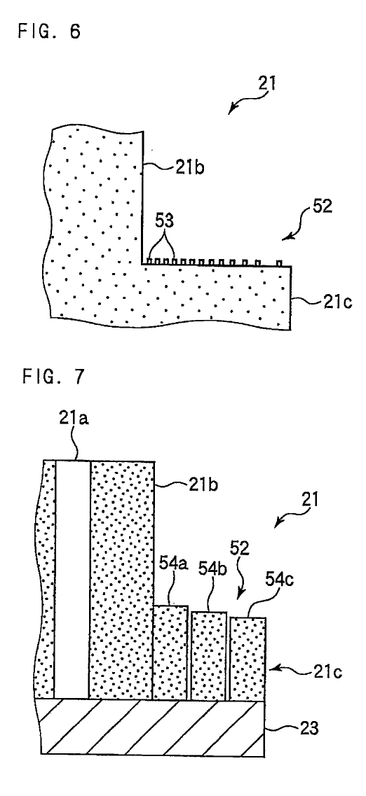

Further, changing part 52 of brush 21 can be formed in such a manner that periphery cleaning part 21c has a different shape along the diameter of periphery cleaning part 21c. For example, changing part 52 of brush 21 can be formed in such as matter that periphery cleaning part 21c has protrusions 53 on its surface and the number of protrusions 53 is increased as it goes toward the inner side of brush 21, as shown in FIG. 6. Therefore, the cleaning performance of brush 21 can be increased as it goes toward the end-surface of wafer W.

Furthermore, as shown in FIG. 7, changing part 52 of brush 21 can be divided into a plurality of brush areas (for example, three brush areas 54a, 54b, and 54c) along the diametrical direction of brush 21. For example, a height of each brush area may be different. Still further, multiple brush areas may have different properties, e.g. different shape, hardness, or material. Two or more among height, shape, hardness, and material may be different for multiple blush areas.

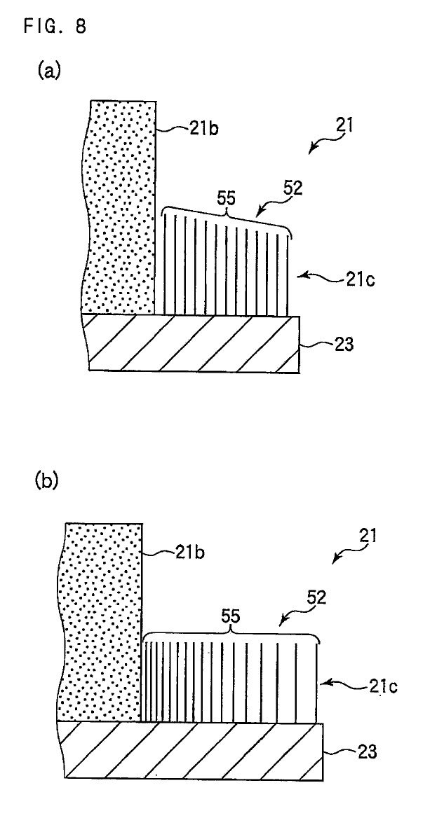

As shown in FIG. 8, changing part 52 may be formed with a bristle assembly 55. Bristles of bristle assembly 55 may be different heights (FIG. 8(a)) or density (FIG 8(b)) along the diametrical direction of periphery cleaning part 21c. In some embodiments, a thickness or material of the bristles can be different along the diametrical direction of periphery cleaning part 21c.

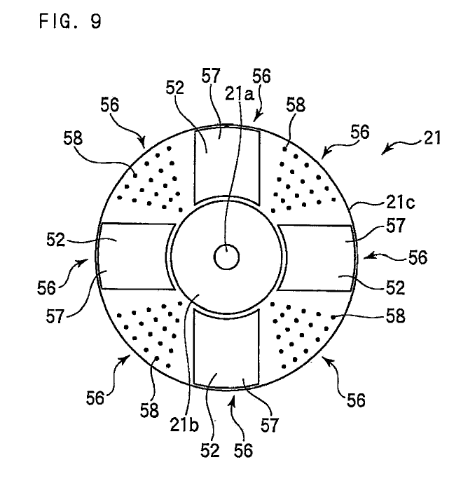

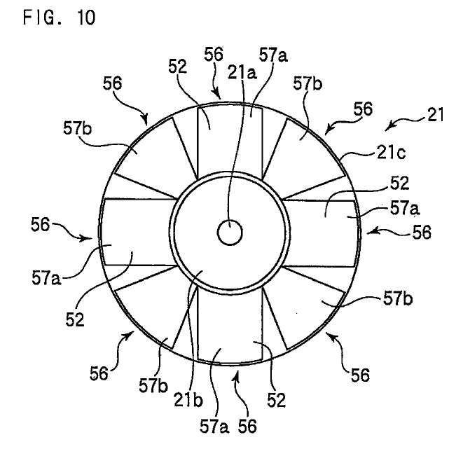

As shown in FIG. 9, periphery cleaning part 21c may be divided into a plurality of brush parts 56 along the circumference of periphery cleaning part 21c. Brush parts 56 may have different properties with respect to adjacent brush parts 56 so that at least one among brush parts 56 functions as changing part 52. For example, as shown in FIG. 9, brush parts 56 formed with a sponge-type resin 57 and brush parts 56 formed with a bristle assembly 58 may be alternately arranged. In this case, a part or entire of brush parts 56 formed with sponge-type resin 57 may function as changing part 52. Alternatively, a part or entire of brush parts 56 formed with bristle assembly 58 may function as changing part 52.

As shown in FIG. 10, when brush parts 56 are entirely formed with sponge-type resin, a first resin 57a and a second resin 57b can be alternately arranged to form brush parts 56. At least one property (for example, height, shape, hardness, or material) of first and second resins 57a and 57b are different from each other, For example, a part or entire of brush parts 56 on which first resin 57a is displaced may function as changing part 52. Alternatively, a part or entire of brush parts 56 on which second resin 57b is displaced may function as changing part 52.

Brush 21 can be attached to brush supporting member 23 with an adhesive. If periphery cleaning part 21c of brush 21 is divided into a plurality of parts, as shown in FIGS. 7 to 10, each division can be directly attached to brush supporting member 23 with the adhesive. A method for attaching brush 21 to brush supporting member 23 can use various methods, such as binding, welding or pressurizing, in addition to the adhesive.

End-surface cleaning part 21b of brush 21 can be formed with a sponge-type resin.

The sponge-type resin used for end-surface cleaning part 21b and periphery cleaning part 21c of brush 21 can include polyvinyl alcohol (PVA). In some embodiments, polyethylene (PE) can be used for the resin of brush 21. Further, the resin of the toothbrush-type bristle assembly used for periphery cleaning part 21c can include polypropylene. Brush supporting member 23 may be formed with a resin. For example, a hard resin, such as polyether ether ketone (PEEK), polyethylene terephthalate (PET, or polyvinyl chloride (PVC) may be used for brush 21 to prevent from deformation of brush 21.

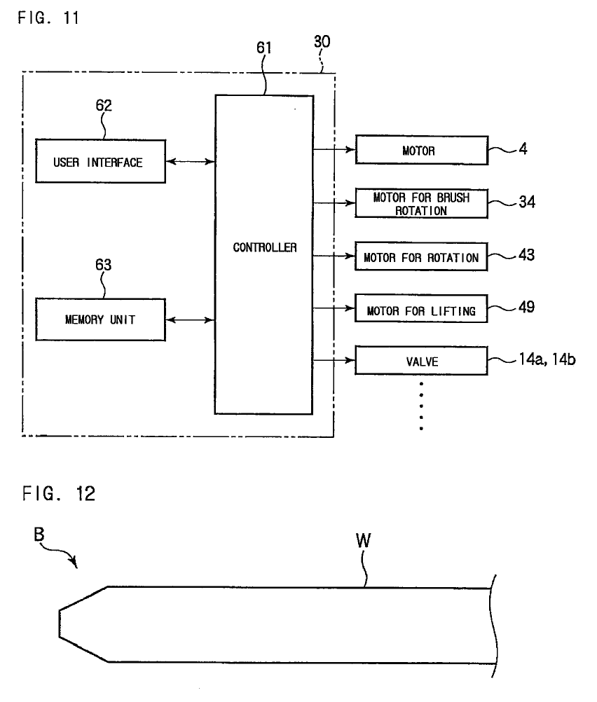

As shown in FIG. 11, a control part 30 includes a controller 61, a user interface 62, and a memory 63. Controller 61 controls each part of substrate cleaning apparatus 1, such as motor 4, motor 34 for brush rotation, motor 43 for rotation, and motor 49 for lifting. Further, user interface 62 is connected with controller 61 and includes a keyboard or a display. With the keyboard, a user can input a command to manage substrate cleaning apparatus 1. The display visualizes and displays the operational condition of substrate cleaning apparatus 1. Further, memory 63 is connected with controller 61 and stores a control program to control a target object of substrate cleaning apparatus 1 or a program to allow substrate cleaning apparatus 1 to perform a predetermined process, that is, a processing recipe. The processing recipe is memorized in a memory medium of memory 63. The memory medium may be a fixable-type memory, such as hard disc, or a portable type memory, such as CD ROM, DVD, and flash memory. Further, the processing recipe may be transferred from another device through, for example, a dedicated line. Further, controller 61 may call a predetermined processing recipe from memory 63 by an instruction of user interface 62 and execute the predetermined processing recipe. Thus, a predetermined work can be performed under the control of controller 61.

Hereinafter, a cleaning process of wafer W by substrate cleaning apparatus 1 will be described.

Brush 21 is attached to rotation supporting member 22. Then, wafer W is loaded into chamber 2 in a state where brush 21 is placed back to an exterior side of wafer W, and wafer W is held onto spin chuck 3. When brush 21 is placed back, cleaning liquid is supplied to brush 21 to prevent brush 21 from drying. In this state, motor 4 is operated so as to rotate wafer W together with spin chuck 3 in a predetermined number of rotations, and brush 21 is rotated with brush supporting member 22 by motor 34 for brush rotation while supplying the cleaning liquid from cleaning liquid nozzle 11 to wafer W.

Then, rotating arm 25 is rotated toward wafer W held on spin chuck 3 by rotating device 42 so as to push a circumference (which has a small diameter) of end-surface cleaning part 21b of brush 21 to an end surface of wafer W with a predetermined pressure power. A height of rotating arm 25 is adjusted by lifting device 45 so as to push an upper surface (which has a large diameter) of periphery cleaning part 21c of brush 21 to a periphery of a rear surface of wafer W with a predetermined pressure power. As a result, a brush cleaning is started.

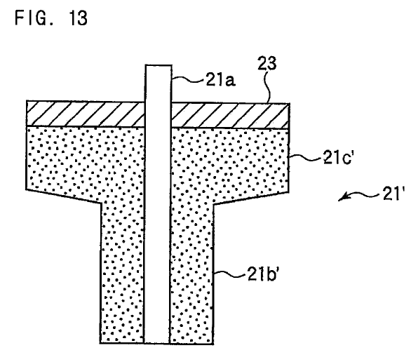

In some embodiments, appropriate brush 21 can be selected considering a shape of wafer W and attached condition of extraneous matters. For examples, because the shape of wafer W and the attached condition of the extraneous matters are different along a diameter of the periphery of wafer W, it is necessary to adjust a cleaning performance along the diameter of the periphery of wafer W. In order to adjust the cleaning performance, changing part 52 of periphery cleaning part 21c can be used. For example, since properties of changing part 52 can be changed along the diameter of periphery cleaning part 21c, the cleaning performance can be adjusted along the diameter in order to distribute the cleaning performance in the diametrical direction of wafer W. For example, as shown in FIG. 12, the periphery of wafer W includes a bevel B. A rear or opposite side of bevel B upwardly inclines upwardly as it goes toward an end surface side of wafer W. Thus, it is difficult to apply a pressure of brush 21 to an area near the end surface of wafer W during cleaning an opposite side of the periphery of wafer W. Thus, it may be necessary to change a property of periphery cleaning part 21c to increase the cleaning performance as it goes toward an inner side of periphery cleaning part 21c along the diameter of periphery cleaning part 21c, for example, the end surface side of wafer W.

In illustrated embodiment of FIG. 4, periphery cleaning part 21c can be entirely formed with a sponge-type resin. In this case, a height of periphery cleaning part 21c increases as it goes toward an inner side along the diameter of periphery cleaning part 21c, so that an entire of periphery cleaning part 21c can function as changing part 52. Generally, it is difficult to clean a bevel (for example, bevel B) of wafer W because a pressure of brush 21 cannot be easily applied to the bevel. However, in the illustrated embodiment, the cleaning performance with respect to the bevel can be improved and thus the periphery of the rear surface of wafer W can be efficiently cleaned. In some embodiments, a part of periphery cleaning part 21c may function as changing part 52.

In illustrated embodiment of FIG. 5, the height of periphery cleaning part 21c can be substantially the same along the diameter of periphery cleaning part 21c. As depicted in FIG. 5, periphery cleaning part 21c becomes solid or has different materials as it goes toward an inner side of periphery cleaning part 21c. Thus, an entire of periphery cleaning part 21c can function as changing part 52. Therefore, the cleaning performance with respect to the bevel can be improved so as to efficiently clean wafer W. In some embodiments, a part of periphery cleaning part 21c can function as changing part 52.

In illustrated embodiment of FIG. 6, periphery cleaning part 21c has a different shape along the diameter of periphery cleaning part 21c. For example, the number of protrusions 53 formed on a surface of periphery cleaning part 21c is increased as it goes towards an inner side of periphery cleaning part 21c. Thus, an entire of periphery cleaning part 21c can function as changing part 52. Therefore, the cleaning performance with respect to the bevel can be improved so as to efficiently clean the periphery of the rear surface of wafer W. In some embodiments, a part of periphery cleaning part 21c can function as changing part 52.

In illustrated embodiment of FIG. 7, periphery cleaning part 21c can be divided into a plurality of brush areas (for example, three brush areas 54a, 54b, and 54c ) along the diameter of periphery cleaning part 21c, and the height of each of the brush areas can be made different so as to form changing part 52. Therefore, the cleaning performance with respect to the bevel, which is difficult to clean, is improved so as to efficiently clean wafer W Further, even though the plurality of brush areas has different properties, for example, different shape, hardness, or material, other than different height, or has two or more different properties among height, shape, hardness, and material, rather than one different property, substrate cleaning apparatus 1 can have the same effect. Further, because changing part 52 is divided into the plurality of brush areas as illustrated above, each division may be attached to brush supporting member 23. Therefore, a desired shape can be easily obtained without a minute processing of the sponge-type resin that is difficult to be processed. In this case, either a part or entire of periphery cleaning part 21c may function as changing part 52.

As illustrated in FIG. 8, changing part 52 can be formed with bristle assembly 55, and a height (diagram (a) of FIG. 8) or density (diagram (b) of FIG. 8) of the bristles can be different along the diametrical direction of periphery cleaning part 21c. Specifically, the height of the bristles (diagram (a) of FIG. 8) becomes higher as it goes towards the inner side of periphery cleaning part 21c. The density of the bristles (diagram (a) of FIG. 8) becomes higher as it goes towards the inner side of periphery cleaning part 21c. Therefore, the cleaning performance with respect to the bevel of wafer W, which is difficult to clean, is improved so as to efficiently clean wafer W. In this case, either a part or entire of periphery cleaning part 21c may function as changing part 52. Further, brush 21 can have different thickness or material along the diametrical direction of periphery cleaning part 21c so as to implement different cleaning performance along the diameter of periphery cleaning part 21c. Therefore, an efficient cleaning can be achieved.

As illustrated in FIG. 9, periphery cleaning part 21c can be divided into a plurality of brush parts 56 along the circumferential direction of periphery cleaning part 21c. Further, properties of adjacent brush parts are be different so that at least one brush part among the plurality of brush parts 56 can function as changing part 52. Brush parts 56 formed with sponge-type resin 57 and brush parts 56 formed with bristle assembly 58 can be alternately arranged. In this case, because brush parts 56 formed with sponge-type resin 57 can function as changing part 52, the cleaning performance with respect to the bevel, which is difficult to clean, can be improved by using changing part 52. Therefore, an efficient cleaning of wafer W can be achieved. Further, brush parts 56 having the different shapes and materials can be alternately arranged in the circumferential direction of periphery cleaning part 21c so that brush parts 56 can be alternately in contact with a target part of wafer W. Therefore, the cleaning performance with respect to an entire periphery of wafer W can be improved.

As illustrated in FIG. 10, periphery cleaning part 21c can be divided into a plurality of brush parts 56 along the circumferential direction of periphery cleaning part 21c. Further, brush part 56 can be entirely formed with the sponge-type resin, and can have first resin 57a and second resin 57b. First and second resins 57a and 57b can have at least one different property, such as height, shape, or hardness, and be alternately arranged. Therefore, one part of brush parts 56, for example, brush part 56 arranged with first resin 57a, can function as changing part 52. Therefore, by using brush part 56 arranged with first resin 57a, the cleaning performance with respect to the bevel, which is difficult to clean, can be improved so as to efficiently clean wafer W. Further, as illustrated above, first resin 57a and second resin 57b in which at least one of height, shape, hardness, and material is different from each other are alternately arranged along the circumferential direction of periphery cleaning part 21c. Therefore, first resin 57a and second resin 57b can be alternately in contact with target parts of wafer W so as to improve the cleaning performance with respect to an entire periphery.

When periphery cleaning part 21c, as illustrated in FIGS. 9 and 10, is divided into a plurality of brush parts 56, a plurality of small parts having various materials and shapes can be attached to brush supporting member 23 to form the plurality of brush parts 56. Therefore, the plurality of brush parts 56 can be easily manufactured.

The present invention is not limited to the above embodiments, but can be variously modified. For example, although it is illustrated that an end surface and a periphery of a rear surface of a wafer are cleaned using a brush in which an upper part of the brush is for cleaning the end-surface of the wafer and a lower part of the brush is for cleaning the periphery of the rear surface of the wafer, the end surface and the periphery of the rear surface of the wafer can be cleaned by using a brush 21′, as illustrated in FIG. 13, in which an upper part of brush 21′ is for cleaning the periphery of the rear surface of the wafer and a lower part of brush 21′ is for cleaning the end-surface of the wafer.

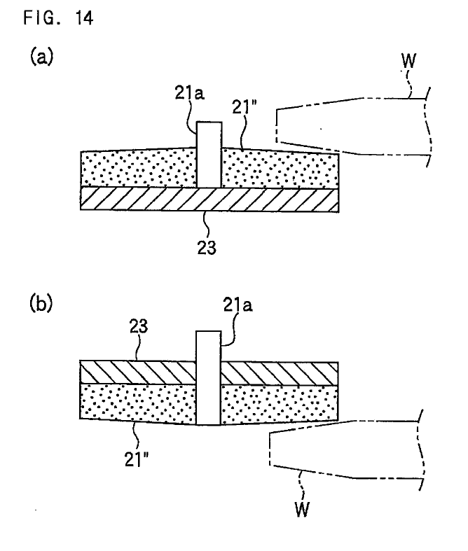

Further, the periphery of the rear surface of wafer W may be cleaned with an upper side of a brush 21″ which has a disc-liked shape as shown in the diagram (a) of FIG. 14, and the periphery of the rear surface of wafer W may be cleaned with a lower side of brush 21″ as shown in the diagram (b) of FIG. 14.

Still further, although the above embodiments are illustrated to achieve efficient cleaning the bevel of the wafer by distributing a cleaning performance, the present invention is not limited thereto. For example, various distributions can be achieved according to the cleaning performance distribution required along the diameter of the periphery of the wafer.

Still further, the shape of the brush is not limited to the above embodiments, but can be formed in various shapes.

Still further, although the above embodiments are illustrate to have the cleaning device to clean the end surface of the wafer and the periphery of the rear surface of the wafer, a cleaning device to clean a surface of the wafer may be provided. Further, the present invention is not limited to the apparatus of the embodiment, but can be applied to the cleaning apparatus to clean the surface/rear surface of the wafer or the apparatus to clean the rear surface of the wafer.

Still further, although a semiconductor wafer is used as a target substrate in the above illustrated embodiment, the present invention is not limited thereto. By way of example of other target substrate, there can be a glass substrate for a liquid crystal display device, for example, a substrate for a flat panel display device.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A substrate cleaning apparatus comprising:
a substrate holding device to rotatably hold a substrate;
a substrate rotation device to rotate the substrate held by the substrate holding device;
a cleaning liquid supplying device to supply cleaning liquid to the substrate held by the substrate holding device; and
a cleaning device comprising a brush and a pressing device, the brush comprising a periphery cleaning part in contact with a periphery of the substrate during cleaning of the substrate, the pressing device pushing the periphery cleaning part to the periphery of the substrate,
wherein the periphery cleaning part comprises a changing part, and a property of the changing part changes along a diameter of the periphery cleaning part to distribute cleaning performance along the diameter.

2. The substrate cleaning apparatus of claim 1, wherein at least one of height, shape, hardness, and material of the changing part is changed along the diameter of the periphery cleaning part.

3. The substrate cleaning apparatus of claim 1, wherein the changing part is divided into a plurality of parts along the diameter of the periphery cleaning part and at least one of height, shape, hardness, and material of the plurality of parts is different between adjacent parts.

4. The substrate cleaning apparatus of claim 1, wherein the cleaning device further comprises a brush rotating device to rotate the brush, and
wherein the brush rotating device rotates the brush and the pressing device pushes the periphery cleaning part to the periphery of the substrate so as to clean the periphery of the substrate.

5. The substrate cleaning apparatus of claim 4, wherein the periphery cleaning part is divided into a plurality of brush parts along a circumferential direction, properties between adjacent brush parts are different, and at least one of the brush parts functions as the changing part.

6. The substrate cleaning apparatus of claim 1, wherein the periphery cleaning part is supported by a brush supporting member.

7. The substrate cleaning apparatus of claim 1, wherein the brush is integrally and coaxially formed with the periphery cleaning part and comprises an end surface cleaning part to be in contact with an end surface of the substrate.

8. The substrate cleaning apparatus of claim 7, wherein the end surface cleaning part is formed with a sponge-type resin.

9. The substrate cleaning apparatus of claim 7, wherein the pressing device pushes
the end surface cleaning part to the end surface of the substrate.
